(19) United States
(12) Patent Application Publication
(10) Pub. No.: US 2025/0026124 A1
(43) Pub. Date: Jan. 23, 2025

(54) LIQUID STORAGE CONTAINER

(71) Applicant: CANON KABUSHIKI KAISHA, Tokyo (JP)

(72) Inventor: TAKAYUKI KAMIMURA, Kanagawa (JP)

(21) Appl. No.: 18/763,250

(22) Filed: Jul. 3, 2024

(30) Foreign Application Priority Data
Jul. 19, 2023 (JP) 2023-117589
Apr. 8, 2024 (JP) 2024-061960

(51) Int. Cl. B41J 2/175

(52) U.S. Cl. CPC B41J 2/17509; B41J 2/17523

(57) ABSTRACT

A liquid storage container includes a filling port from which a liquid is filled; an injection port from which the filled liquid is injected into an external apparatus; a filling port placement surface in which the filling port is provided; and an injection port placement surface which is adjacent to the filling port placement surface, which forms a liquid storage space together with the filling port placement surface, and in which the injection port is provided. In a posture of the liquid storage container in injecting the liquid from the injection port into the external apparatus, the injection port is located at a higher position than the filling port is.

### BACKGROUND OF THE INVENTION

### Field of the Invention

The disclosure relates to a liquid storage container and specifically relates to a liquid storage container configured to store a liquid, the liquid storage container capable of being refilled with a liquid such as an ink and supplying the refilled liquid to an external apparatus.

### Description of the Related Art

As a liquid storage container of this type, for example, there is an ink tank configured to store an ink to be supplied to an ink ejection head in an inkjet printing apparatus and be refilled with the ink in a case where the stored ink runs low. As a liquid storage container in another model, there is a liquid storage bottle configured to store an ink to be refilled to an ink tank as described above and supply the ink to the ink tank. In some of these liquid storage containers, an injection port for supplying a liquid to an external apparatus and a filling port for refilling the liquid are separately provided from the viewpoint of user's work efficiency.

In a liquid storage container described in Japanese Patent Laid-Open No. 2013-949 (hereinafter referred to as Patent Document 1), an injection port for supplying a liquid to an ejection head of a liquid ejection apparatus is provided at a bottom portion of the liquid storage container, whereas a filling port for refilling the liquid is provided at a top portion of the liquid storage container.

In the liquid storage container described in Patent Document 1, however, the injection port for supplying the ink to another predetermined part (ejection head) is located at the lowest position in the container during the injection. For this reason, if a foreign substance gets mixed in the storage container at a time of the liquid filling into the storage container or if a solidified ink particle or the like is generated, the foreign substance may move to the lowest position in the container at a time of the liquid injection, and then move to the predetermined part along with the liquid supply. In this case, if the predetermined part is, for example, the ejection head, the moved foreign substance impairs the ejection function.

### SUMMARY OF THE INVENTION

The disclosure provides a liquid storage container including a filling port from which a liquid is filled; an injection port from which the filled liquid is injected into an external apparatus; a filling port placement surface in which the filling port is provided; and an injection port placement surface which is adjacent to the filling port placement surface, which forms a liquid storage space together with the filling port placement surface, and in which the injection port is provided, wherein in a posture of the liquid storage container in injecting the liquid from the injection port into the external apparatus, the injection port is located at a higher position than the filling port is.

Further features of the invention will become apparent from the following description of exemplary embodiments with reference to the attached drawings.

### BRIEF DESCRIPTION OF THE DRAWINGS

FIG. 1 is a perspective view illustrating a liquid ejection apparatus;

FIG. 2 is a perspective view illustrating an internal structure of essential parts of the liquid ejection apparatus illustrated in FIG. 1;

FIG. 3A is a diagram for explaining a liquid storage bottle as a liquid storage container according to a first embodiment of the disclosure;

FIG. 3B is a diagram for explaining the liquid storage bottle as the liquid storage container according to the first embodiment of the disclosure;

FIG. 3C is a diagram for explaining the liquid storage bottle as the liquid storage container according to the first embodiment of the disclosure;

FIG. 4A is a diagram for explaining a liquid storage bottle as a liquid storage container according to a second embodiment of the disclosure;

FIG. 4B is a diagram for explaining the liquid storage bottle as the liquid storage container according to the second embodiment of the disclosure;

FIG. 5A is a diagram for explaining a liquid storage bottle as a liquid storage container according to a third embodiment of the disclosure;

FIG. 5B is a diagram for explaining the liquid storage bottle as the liquid storage container according to the third embodiment of the disclosure;

FIG. 5C is a diagram for explaining the liquid storage bottle as the liquid storage container according to the third embodiment of the disclosure;

FIG. 6A is a diagram for explaining a liquid storage bottle as a liquid storage container according to a fourth embodiment of the disclosure;

FIG. 6B is a diagram for explaining the liquid storage bottle as the liquid storage container according to the fourth embodiment of the disclosure;

FIG. 7A is a diagram for explaining a liquid storage bottle as a liquid storage container according to a fifth embodiment of the disclosure;

FIG. 7B is a diagram for explaining the liquid storage bottle as the liquid storage container according to the fifth embodiment of the disclosure;

FIG. 8A is a diagram for explaining a liquid storage bottle as a liquid storage container according to a sixth embodiment of the disclosure; and

FIG. 8B is a diagram for explaining the liquid storage bottle as the liquid storage container according to the sixth embodiment of the disclosure.

### DESCRIPTION OF THE EMBODIMENTS

Hereinafter, embodiments for carrying out the disclosure will be described in detail with reference to the drawings. It should be noted that the dimensions, materials, shapes, and relative positions of constituent components in the following embodiments can be altered as appropriate depending on a structure and various conditions of a liquid ejection head and the like to which the disclosure is applied. The scope of the disclosure should not be limited to the following embodiments.

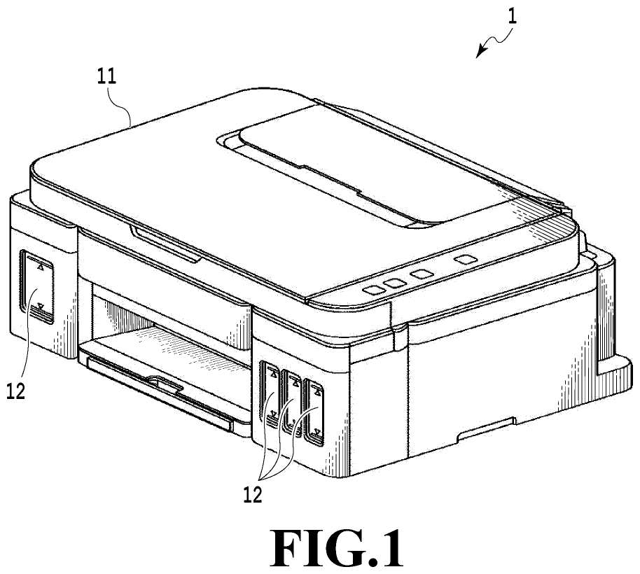

FIG. 1 is a perspective view illustrating an external appearance of a liquid ejection apparatus 1 which uses, as a refill container, a liquid storage container according to an embodiment of the disclosure. The liquid ejection apparatus 1 is a printing apparatus configured to perform printing in a serial method, and includes a housing 11 and liquid tanks 12 placed inside the housing 11. The liquid tanks 12 store inks as liquids to be ejected from a print head onto a printing medium (not illustrated).

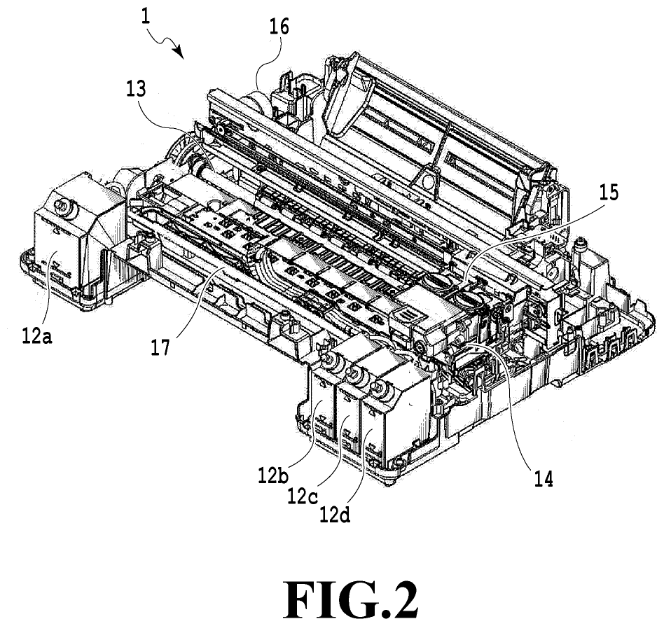

FIG. 2 is a perspective view illustrating an internal structure of essential parts of the liquid ejection apparatus 1 illustrated in FIG. 1. As illustrated in FIG. 2, the liquid ejection apparatus 1 includes a conveyance roller 13 for conveying a printing medium (not illustrated), a carriage 15 on which a print head 14 for ejecting the inks is removably mounted, and a carriage motor 16 for driving the carriage 15. The printing medium is, for example, paper or the like, and may be any medium on which an image can be formed with the liquids ejected from the print head 14.

The conveyance roller 13 is intermittently driven to rotate to transport the printing medium intermittently. The carriage 15 is driven to rotate by the carriage motor 16 to reciprocate in directions intersecting a direction in which the printing medium is conveyed by the conveyance roller 13. An image or the like is printed on the printing medium by repeating a step of ejecting the inks onto the printing medium from ejection ports of the print head 14 on the carriage 15 during the above reciprocating scanning and a step of conveying the printing medium by a predetermined amount.

The inks are stored in the liquid tanks 12, supplied to the print head 14 through liquid channels 17, and ejected from the print head 14. In the embodiment, inks of four colors (for example, cyan, magenta, yellow, and black) are used as the liquids, and four color-specific liquid tanks 12a to 12d for storing the respective color inks are provided as the liquid tanks 12. The color-specific liquid tanks 12a to 12d are arranged at a front side portion of the liquid ejection apparatus 1 inside the housing 11.

In the embodiment, these liquid tanks 12a to 12d are filled and refilled with the inks from respectively corresponding liquid storage bottles (not illustrated).

### First Embodiment

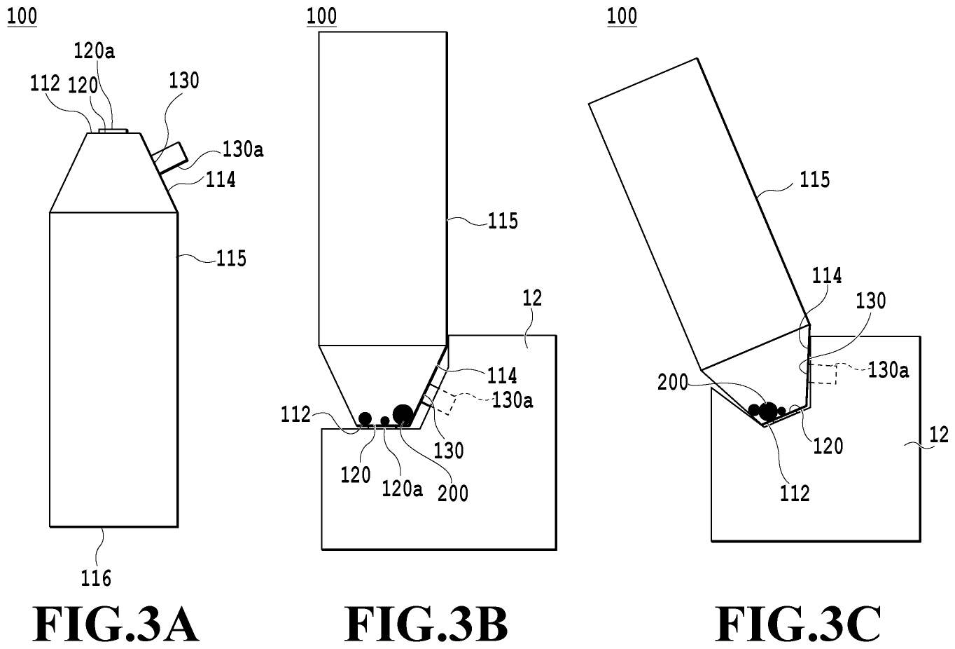

FIG. 3A to 3C are diagrams for explaining a liquid storage bottle as a liquid storage container according to a first embodiment of the disclosure.

FIG. 3A illustrates a standing state of a liquid storage bottle 100. The liquid storage bottle 100 in the standing state has, as outer surfaces, a top surface 112, a first side surface 114 which is a sloped surface of a truncated cone portion adjacent to the top surface, a second side surface 115 which is a side surface of a cylindrical portion adjacent to the first side surface 114, and a bottom surface 116 which is opposed to the top surface 112 and which is adjacent to the second side surface 115. The top surface 112 is a filling port placement surface of the liquid storage bottle 100, and is provided with a filling port 120 that is an opening for filling and refilling the liquid storage bottle 100 with the ink.

The top surface 112 forms a liquid storage space of the liquid storage bottle 100 together with the first side surface 114. More specifically, the top surface 112 forms the liquid storage space of the liquid storage bottle 100 together with the first side surface 114 and the second side surface 115.

This filling port 120 can be closed with a lid 120a. The first side surface 114 is an injection port placement surface of the liquid storage bottle 100, and is provided with an injection port 130 for refilling the aforementioned liquid tank 12 in FIG. 1 with the ink. A spout pipe 130a is provided so as to be connected to the injection port 130. This spout pipe 130a is a cylindrical pipe extending in an outward direction approximately vertical to the first side surface 114, and makes it easy to inject the ink into the liquid tank 12 from the injection port 130. After the liquid storage bottle 100 runs low or out of the stored ink as a result of injecting the ink into the liquid tank 12, the liquid storage bottle 100 is reusable by being filled with the ink again.

Regarding a positional relationship between the filling port 120 and the injection port 130 according to the first embodiment, in the standing state of the liquid storage bottle 100 (FIG. 3A), the filling port 120 is arranged at the highest level in the liquid storage bottle 100, and the injection port 130 is arranged in the first side surface 114 located below the highest level. The first side surface 114 has a shape tapered toward the filling port 120. As a result, firstly, since the injection port 130 is provided in the first side surface 114, the injection port 130 can be oriented to face upward from the horizontal, and an ink leakage through the injection port 130 can be prevented in the standing state of the liquid storage bottle 100. Secondly, in a state where the ink is injected into the liquid tank 12 as illustrated in FIG. 3B, the filling port 120 is located at the lowest level in the liquid storage bottle 100 and the injection port 130 is located above the lowest level. As a result, even if foreign substances 200 exist in the liquid storage bottle 100, the foreign substances 200 stay between the injection port 130 and the filling port 120 (illustrated as black circles 200 in FIG. 3B), and the foreign substances 200 are prevented from moving into the liquid tank 12 through the injection port 130.

There may be a case where the filling port 120 is not located at the lowest level in the injection to the liquid tank 12 as in an example illustrated in FIG. 3C. Even in this injection state, the injection port 130 only has to be located at a higher position than the filling port 120 is.

In order to more certainly prevent foreign substances from mixing in, filters may be provided to the filling port 120 and the injection port 130. In addition, in order to prevent a user from confusing the injection port 130 and the filling port 120, their functions may be indicated near the respective ports 130 and 120 on an outer surface of the liquid storage bottle 100.

As described above, even though the liquid storage bottle 100 according to the embodiment has the structure including the filling port 120 in addition to the injection port 130, it is possible to reduce the risk that foreign substances may enter the liquid tank 12 from the injection port during the liquid filling. In other words, the liquid storage bottle 100 according to the embodiment has the structure capable of promoting reuse of the liquid storage bottle 100 because the liquid storage bottle 100 ensures the user's work efficiency and is easy to reuse by being refilled with the liquid. In sum, the technique described herein can contribute to the realization of a sustainable society such as a decarbonized/recycling society.

### Second Embodiment

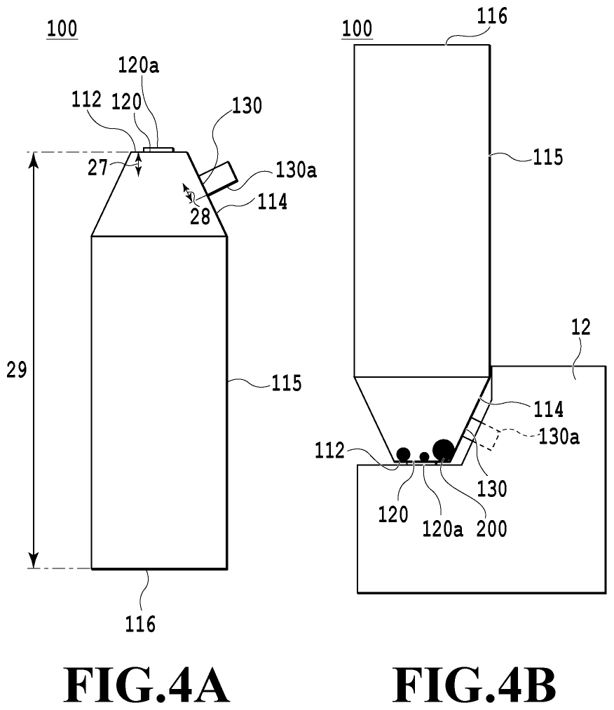

FIGS. 4A and 4B are diagrams for explaining a liquid storage bottle as a liquid storage container according to a second embodiment of the disclosure. The liquid storage bottle in the embodiment has the aforementioned positional relationship between the filling port 120 and the injection port 130 according to the first embodiment, and additionally is defined as having the following relationship between a vertical distance between the filling port 120 and the injection port 130 and an opening width of the injection port 130.

As illustrated in FIG. 4A, a distance 27 between the top surface 112 in which the filling port 120 is opened and the highest end of the injection port 130 in the first side surface 114 (the distance between the injection port and the filling port in a direction perpendicular to the filling port placement surface) is determined to be equal to or larger than an opening width 28 of the injection port 130 (the diameter of the opening in the embodiment). Thus, even if a foreign substance 200 larger than the opening width 28 of the injection port 130 exists in the liquid storage bottle 100, the foreign substance 200 can be confined below the injection port 130 in the injection state illustrated in FIG. 4B. As a result, the large foreign substance 200 can be prevented from, for example, closing the injection port 130 and stopping the injection.

On the other hand, if the above distance 27 is too large, the amount of the ink remaining in the bottle 100 without being injected will increase, which is undesirable. For this reason, in the embodiment, the distance 27 is set to 1/20 or more to ⅕ or less of a height 29 of the liquid storage bottle 100 (a distance between the top surface 112 and the surface (the bottom surface 116) opposed to the top surface 112 in the liquid storage bottle). For example, if the height 29 of the liquid storage bottle 100 is 100 mm, the distance 27 between the injection port 130 and the filling port 120 may be set to 6 mm. As a result, it is possible to obtain a liquid storage bottle in which the foreign substance 200 can be confined between the injection port 130 and the filling port 120 during the ink injection and the amount of the remaining ink can be reduced.

### Third Embodiment

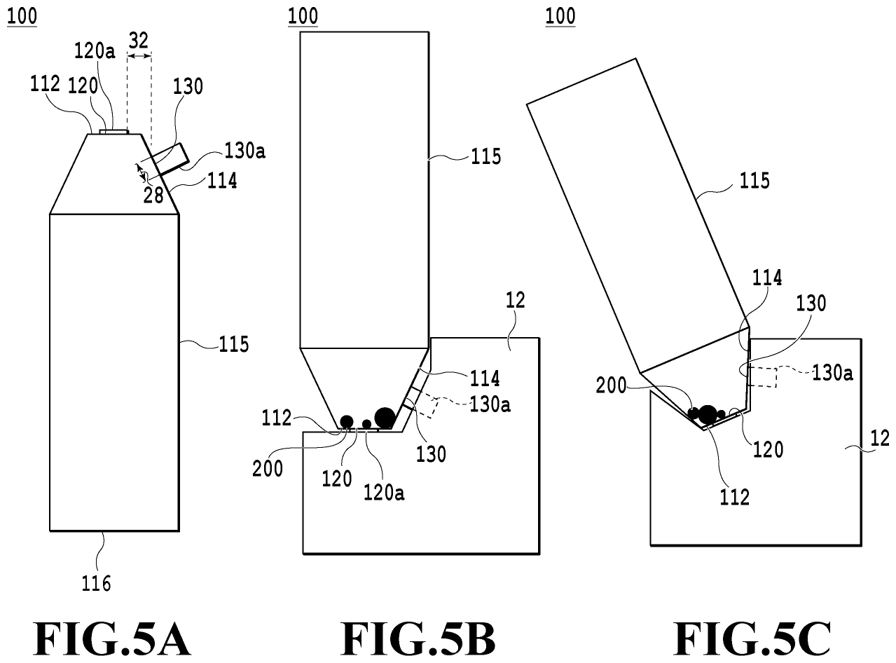

FIGS. 5A to 5C are diagrams for explaining a liquid storage bottle as a liquid storage container according to a third embodiment of the disclosure. The liquid storage bottle in the embodiment has the aforementioned structure according to the first embodiment and additionally is defined as having the following relationship between a horizontal distance between the filling port 120 and the injection port 130 and the opening width 28 of the injection port 130.

As illustrated in FIG. 5A, in the horizontal direction, a distance 32 between the end of the filling port 120 closest to the injection port 130 and the end of the injection port 130 closest to the filling port 120 (the distance between the injection port and the filling port in the direction orthogonal to the direction perpendicular to the filling port placement surface) is determined to be larger than the opening width 28 of the injection port 130. As a result, even if a foreign substance 200 larger than the opening width 28 of the injection port 130 exists in the liquid storage bottle 100 in filling or refilling the liquid storage bottle 100 with the ink via the filling port 120, the foreign substance 200 can be kept away from the injection port 130 in the injection state illustrated in FIG. 5B. As a result, the large foreign substance 200 can be prevented from, for example, closing the injection port 130 and stopping the injection. In the embodiment, for example, in a case where the opening width 28 is 5 mm, the minimum horizontal distance 32 between the filling port 120 and the injection port 130 is 6 mm.

### Fourth Embodiment

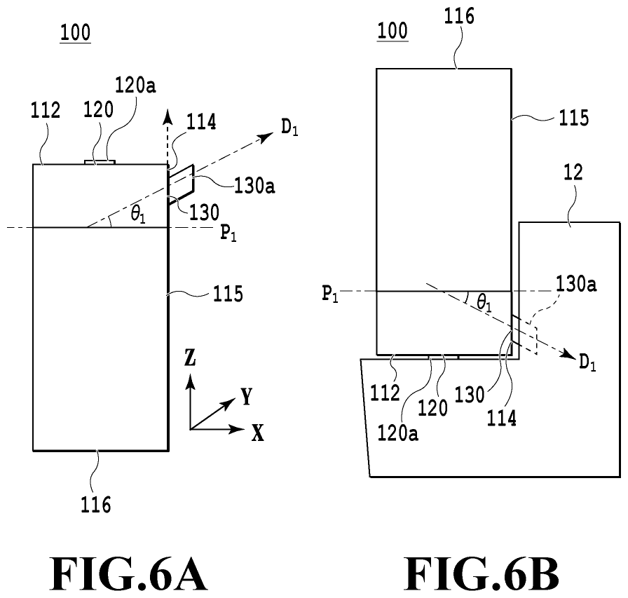

FIGS. 6A and 6B are diagrams for explaining a liquid storage bottle as a liquid storage container according to a fourth embodiment of the disclosure. The liquid storage bottle in the embodiment relates to a structure in which an angle of the spout pipe 130a extending from the injection port 130 is determined in addition to the aforementioned structure according to the first embodiment. Specifically, as illustrated in FIGS. 3 to 5 for the first to third embodiments, the spout pipe 130a extends in an obliquely upward direction in the standing state of the liquid storage bottle. As a result, due to the action of gravity, a foreign substance can be prevented from entering the spout pipe 130a through the injection port 130.

As in the embodiment, in a case where a side surface 114 is a surface that extends along the vertical direction and is orthogonal to the top surface 112, the angle of the obliquely upper direction can be expressed as an angle θ1 illustrated in FIG. 6A. More specifically, the angle θ1 formed between an extending direction D1 of the spout pipe 130a and the bottom surface 116 of the liquid storage bottle 100 in the standing state is a value within a range of more than 0° to less than 90°. Preferably, the angle θ1 is a value within a range of 70° or more to less than 90°. In the case where the angle θ1 is within this range, a foreign substance can be more effectively prevented from entering the spout pipe 130a as described above.

In addition, in the case where the spout pipe 130a faces upward from the horizontal as described above, the ink can be prevented from leaking through the injection port 130 and it is easier to inject the ink into the liquid tank 12 from the injection port 130 because the injection port 130 faces downward from the horizontal when the ink is injected into the liquid tank 12.

### Fifth Embodiment

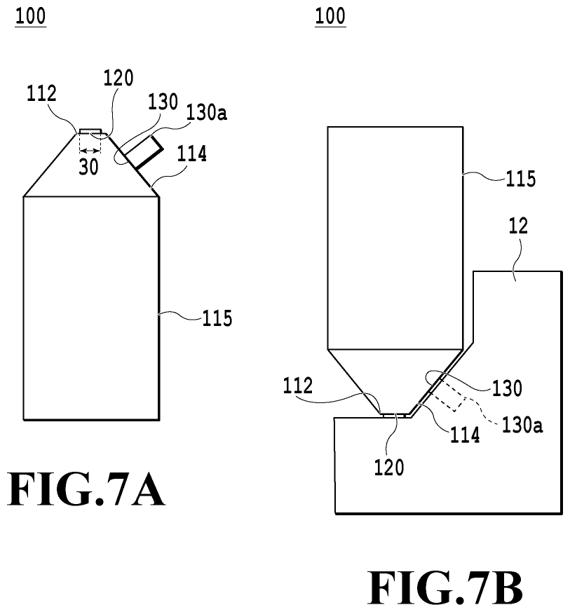

FIGS. 7A and 7B are diagrams for explaining a liquid storage bottle as a liquid storage container according to a fifth embodiment of the disclosure. In addition to the aforementioned structure according to the first embodiment, the liquid storage bottle in the embodiment has a structure in which an area of the top surface 112 is reduced as compared with the liquid storage bottles in the first to third embodiments. Accordingly, an opening area of the filling port 120 is reduced.

As a result, the volume of a space formed between the injection port 130 and the filling port 120 can be reduced and therefore the amount of the ink that can remain in this space can be reduced.

### Sixth Embodiment

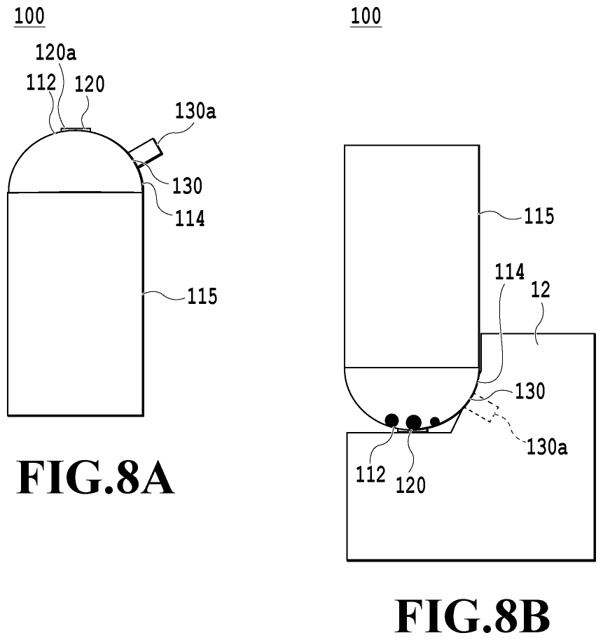

FIGS. 8A and 8B are diagrams for explaining a liquid storage bottle as a liquid storage container according to a sixth embodiment of the disclosure.

The liquid storage bottle in the embodiment has a structure in which the top surface 112 and the first side surface 114 are curved surfaces in addition to the aforementioned structure according to the first embodiment.

Since the liquid storage bottle in the embodiment has such structure, possibly existing foreign substances are caused by the gravity to concentrate and remain near the lowest position in the liquid storage bottle 100 as illustrated in FIG. 8B when the ink is injected into the liquid tank 12 from the injection port 130. As a result, the foreign substances can be prevented from, for example, remaining near and sticking to the injection port 130.

### Other Embodiments

It is clear from the above description that any combination of the first to sixth embodiments described above is included in an embodiment of the invention as long as it is not inconsistent to the gist of the invention.

In addition, the shape of the liquid storage container is not limited to the bottle shape, but the liquid storage container may be any container including a filling port placement surface provided with a filling port and an injection port placement surface provided with an injection port and satisfying the foregoing features in each of the embodiments.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-117589, filed Jul. 19, 2023, and No. 2024-061960, filed Apr. 8, 2024, which are hereby incorporated by reference wherein in their entirety.

What is claimed is:

1. A liquid storage container comprising:
a filling port from which a liquid is filled;
an injection port from which the filled liquid is injected into an external apparatus;
a filling port placement surface in which the filling port is provided; and
an injection port placement surface which is adjacent to the filling port placement surface, which forms a liquid storage space together with the filling port placement surface, and in which the injection port is provided, wherein
in a posture of the liquid storage container in injecting the liquid from the injection port into the external apparatus, the injection port is located at a higher position than the filling port is.

2. The liquid storage container according to claim 1, wherein a distance between the injection port and the filling port in a direction perpendicular to the filling port placement surface is larger than an opening width of the injection port.

3. The liquid storage container according to claim 2, wherein the distance between the injection port and the filling port in the direction perpendicular to the filling port placement surface is 1/20 or more to ⅕ or less of a distance between the filling port placement surface and a surface of the liquid storage container opposed to the filling port placement surface.

4. The liquid storage container according to claim 1, wherein a distance between the injection port and the filling port in a direction orthogonal to a direction perpendicular to the filling port placement surface is larger than an opening width of the injection port.

5. The liquid storage container according to claim 1, further comprising a spout pipe connected to the injection port, wherein
an angle formed between an extending direction of the spout pipe and a surface of the liquid storage container opposed to the filling port placement surface is a value within a range of more than 0° to less than 90°.

6. The liquid storage container according to claim 5, wherein the angle formed between the extending direction of the spout pipe and the surface of the liquid storage container opposed to the filling port placement surface is a value within a range of 70° or more to less than 90°.

7. The liquid storage container according to claim 1, wherein the injection port placement surface has a shape tapered toward the filling port.

8. The liquid storage container according to claim 1, wherein the filling port placement surface and the injection port placement surface are curved surfaces.

9. The liquid storage container according to claim 1, wherein indications indicating the injection port and the filling port are provided on the liquid storage container.
